(19) United States
(12) Patent Application Publication
(10) Pub. No.: US 2016/0167203 A1
(43) Pub. Date: Jun. 16, 2016

(54) RATCHET WRENCH ABLE TO ENHANCE POSITIONING EFFECT OF RATCHET

(71) Applicant: Chia-Yu CHEN, Taichung City (TW)

(72) Inventor: Chia-Yu CHEN, Taichung City (TW)

(21) Appl. No.: 14/571,502

(22) Filed: Dec. 16, 2014

(51) Int. Cl. B25B 13/46; B25B 23/00

(52) U.S. Cl. CPC B25B 13/463; B25B 23/0007

(57) ABSTRACT

A ratchet wrench structure able to enhance the positioning effect of a ratchet includes a control member. The control member is longitudinally provided with a prop pin which has a rectangular slab shape. The prop pin longitudinally holds against a contact surface of a detent block to increase the area for applying the force. The detent block from top to bottom meshes with a ratchet ring, enhancing the positioning effect of the ratchet and stability of engagement. This won't have the problem of a partial engagement, preventing the teeth from breaking. The prevent invention can overcome the parallelism and perpendicularity tolerance problem that the conventional ratchet wrench uses a plurality of elastic positioning members to hold against the detent block.

### BACKGROUND OF THE INVENTION

1. Field of the Invention

The present invention relates to a ratchet wrench structure, and more particularly to a ratchet wrench structure able to enhance the positioning effect of a ratchet.

2. Description of the Prior Art

As shown in FIG 1, a conventional ratchet wrench comprises a detent block 1 to lean against the inner wall of an accommodation trough 4, such that the detent block 1 and a ratchet ring 2 mesh with each other. However, the detent block 1 is biased by an elastic member 3 at one side only. The back of the detent block 1 is suspended in midair, without any support. When the force applied to the detent block 1 reaches a certain value, the suspended back won't withstand the force so it will not generate any counterforce. The detent block 1 will use the support at one side thereof as a fulcrum to swing, and the teeth of the detent block 1, at the other end, will slightly disengage from the ratchet ring to bring a seesaw effect. The seesaw effect will make some teeth of the detent block be applied with the force to mesh the ratchet ring. The teeth of the detent block may burst into pieces, which will result in breakage of the ratchet wrench.

In view of the aforesaid, a ratchet wrench having a dual rigid fulcrum is developed on the market, as shown in FIG. 2. The detent block 1 of this ratchet wrench is biased by the elastic member 3, and the curved surface at one end of the detent block 1 leans against the inner wall of the accommodation trough 4. The other end of the detent block 1 is biased by a prop member 5 which holds against the top of a concave portion 6. Both ends of the detent block 1 are held by rigid fulcrums, respectively. When in use, the teeth of the detent block 1 are meshed with the teeth of the ratchet ring 2. The force applied to each tooth is even, so all the teeth are in an engagement state. This ratchet wrench doesn't have the problem that only some teeth are applied with the force. The number of the teeth to mesh with the ratchet ring is more than that of the conventional detent block and the engagement of the teeth is more stable, so the ratchet wrench can bear more torque value.

Though the detent block 1 of this ratchet wrench is biased by the elastic member 3 for one end of the detent block 1 to lean against the inner wall of the accommodation trough 4, and the other end is held by the prop member 5 to form rigid fulcrums at the left and right ends of the detent block 1. However, the elastic member 3 only holds against the upper portion of the detent block 1, so the force applied to the upper and lower portions of the detent block 1 is not even. When the force applied to the detent block 1 reaches a certain value, the lower portion of the detent block 1, without any support, may disengage from the ratchet ring 2.

Referring to FIG. 3 to FIG. 5, another conventional ratchet wrench uses the elastic member 3 to contact with the detent block 1, such that the detent block 1 is able to mesh with the outer periphery of the ratchet ring 2. Only one side of the detent block 1 is propped. The other side of the detent block 1 is suspended in midair, without any support. When the force applied to the detent block 1 reaches a certain value, the suspended side won't withstand the force so it will not generate any counterforce. The detent block 1 will use the support at one side thereof as a fulcrum to swing, and the teeth of the detent block 1, at the other end, will slightly disengage from the ratchet ring to bring a seesaw effect. The seesaw effect will make the force applied to the teeth of the detent block 1 uneven. The teeth of the detent block may burst into pieces, which will result in breakage of the ratchet wrench.

In view of this, another ratchet wrench is developed, as shown in FIG. 6. The ratchet wrench comprises a control member 7. One side of the control member 7, facing the detent block 1, is formed with two limit grooves 8. Each limit groove 8 is provided with an elastic member 3. The limit groves 8 are arranged at the upper and lower portions of the control member 7, so that the elastic members 8 are to prop the upper and lower positions of the detent block 1, respectively. Therefore, the upper and lower portions of the detent block 1 mesh with the ratchet ring 2 at the same time. When in use, if there is greasy dirt between the upper and lower portions of the detent block 1 to influence the state of engagement, the elastic members 3 can overcome the obstruction, enabling the upper and lower portions of the detent block 1 to mesh with the ratchet ring 2 at the same time, avoiding the seesaw effect which causes a partial engagement.

However, it is hard to control the parallelism and perpendicularity between the holes, troughs, grooves formed in the ratchet wrench within a precise tolerance. This causes a high cost to process the ratchet wrench, and influences the production efficiency. If the parallelism and perpendicularity between the holes, troughs, grooves formed in the ratchet wrench is within a normal tolerance, the degree for the detent block 1 and the ratchet ring 2 to mesh with each other is not good, or the detent block 1 and the ratchet ring 2 are unable to mesh with each other completely to cause a breakage of the teeth. Accordingly, the inventor of the present invention has devoted himself based on his many years of practical experiences to solve these problems.

### SUMMARY OF THE INVENTION

The primary objective of the present invention is to provide a ratchet wrench structure able to enhance the positioning effect of a ratchet. The ratchet wrench structure of the present invention can avoid the problem that a detent block and a ratchet ring are partially meshed with each other to result in breakage of teeth. The prevent invention can overcome the parallelism and perpendicularity tolerance problem that the conventional ratchet wrench uses a plurality of elastic positioning members to hold against the detent block, enhancing the positioning effect of the ratchet and stability of engagement.

In order to achieve the aforesaid objective, the ratchet wrench structure of the present invention comprises a wrench main body. The wrench main body has a handle. One end of the handle has a head portion. The head portion has an accommodation hole. The head portion is longitudinally formed with a control trough close to the handle. The head portion is transversely formed with a detent trough communicating with the control trough. A ratchet ring is pivotally disposed in the accommodation hole. The outer wall of the ratchet ring is formed with a plurality of drive teeth. The center of the ratchet ring is provided with an activating member. The activating member is adapted to turn a workpiece. A detent block is provided in the detent trough. One side of the detent block, facing the accommodation hole, has a plurality of teeth thereon. The teeth are adapted to mesh with the drive teeth of the ratchet ring. Another side of the detent block, facing the control trough, has a contact surface. A control device is provided in the control trough. The control device comprises a control member. One side of the control member, facing the detent trough, is longitudinally formed with a rectangular limit groove. The rectangular limit groove is adapted to accommodate a rectangular spring. A prop pin is provided and biased by the rectangular spring. The prop pin has a rectangular slab shape corresponding to the rectangular limit groove. The prop pin longitudinally holds against the contact surface of the detent block. The control member is provided with a switch member, and the switch member is exposed out of the head portion.

The ratchet wrench structure of the present invention is able to enhance the positioning effect of the ratchet. The prop pin longitudinally holds against the contact surface of the detent block to increase the area for applying the force. The detent block from top to bottom meshes with the ratchet ring. This won't have the problem of a partial engagement, increasing the stability of engagement and preventing the teeth from breaking. The prevent invention can overcome the parallelism and perpendicularity tolerance problem that the conventional ratchet wrench uses a plurality of elastic positioning members to hold against the detent block.

### BRIEF DESCRIPTION OF THE DRAWINGS

FIG. 1 is a transverse sectional view of a first conventional ratchet wrench;

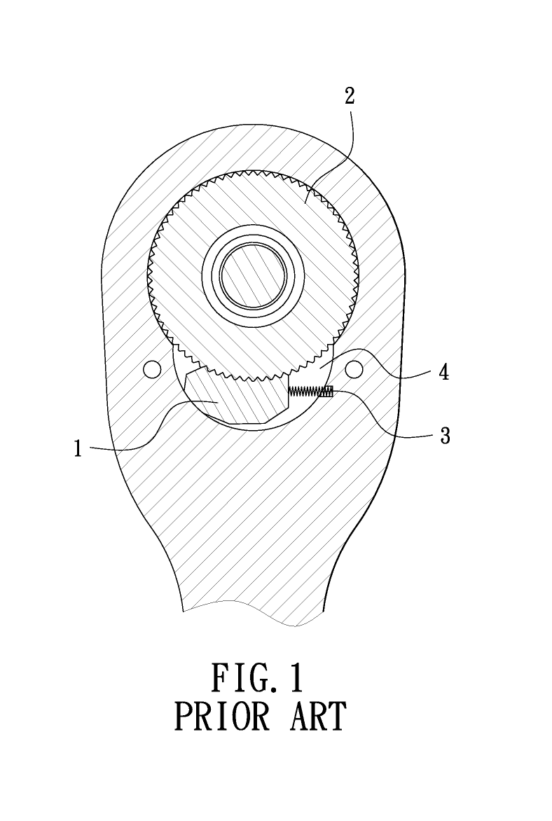

FIG. 2 is a transverse sectional view of a second conventional ratchet wrench;

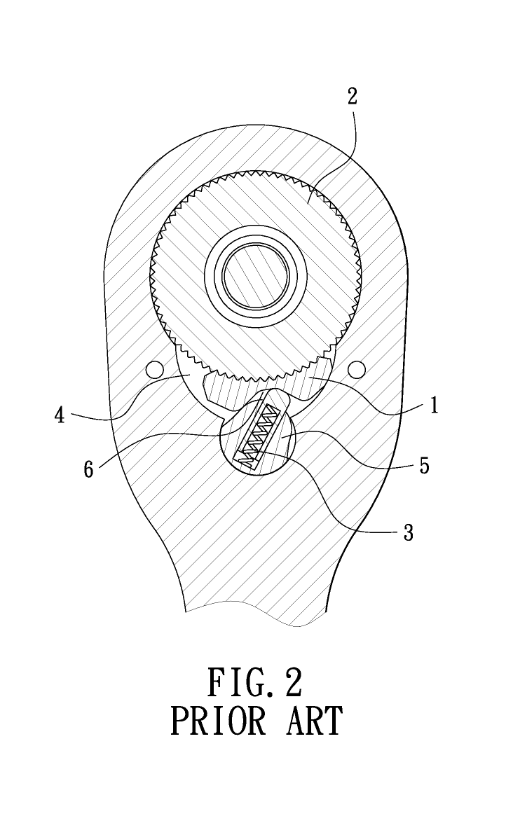

FIG. 3 is a longitudinal sectional view of a third conventional ratchet wrench;

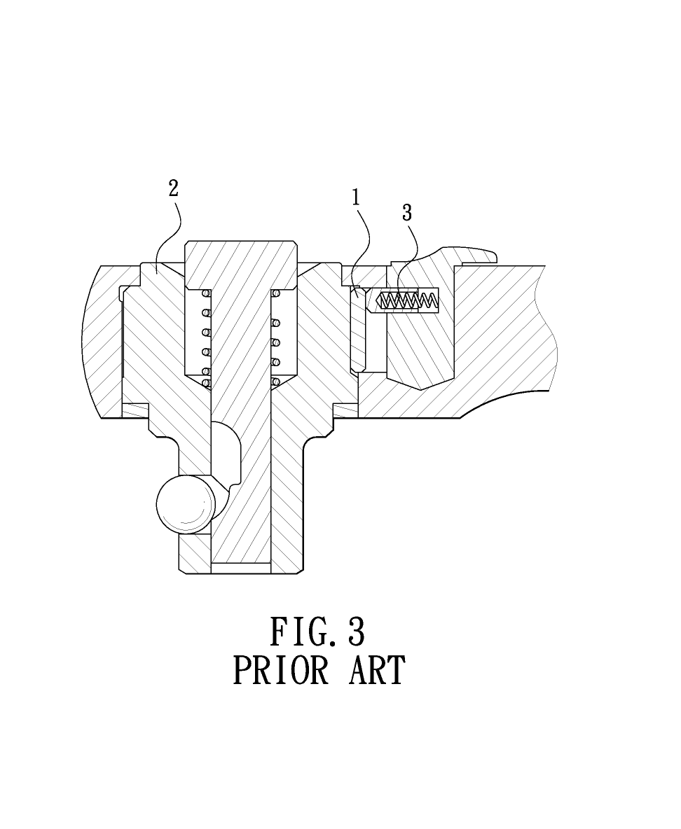

FIG. 4 is a transverse sectional view of the third conventional ratchet wrench;

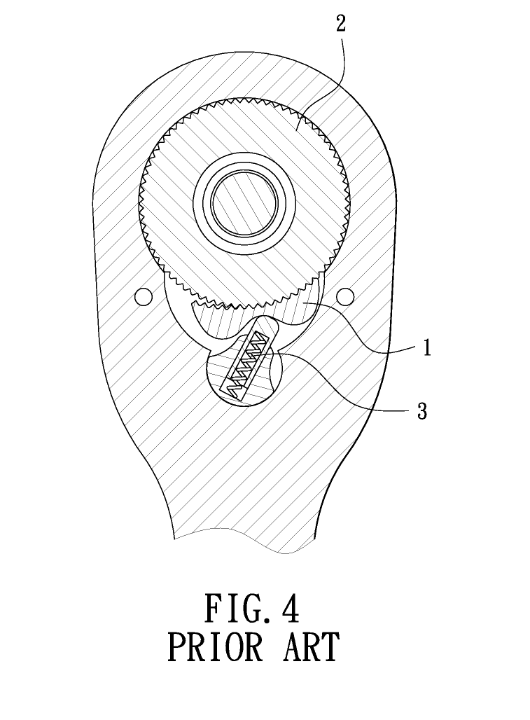

FIG. 5 is a schematic view of the third conventional ratchet wrench, showing the state of the detent biased by the spring and the prop member;

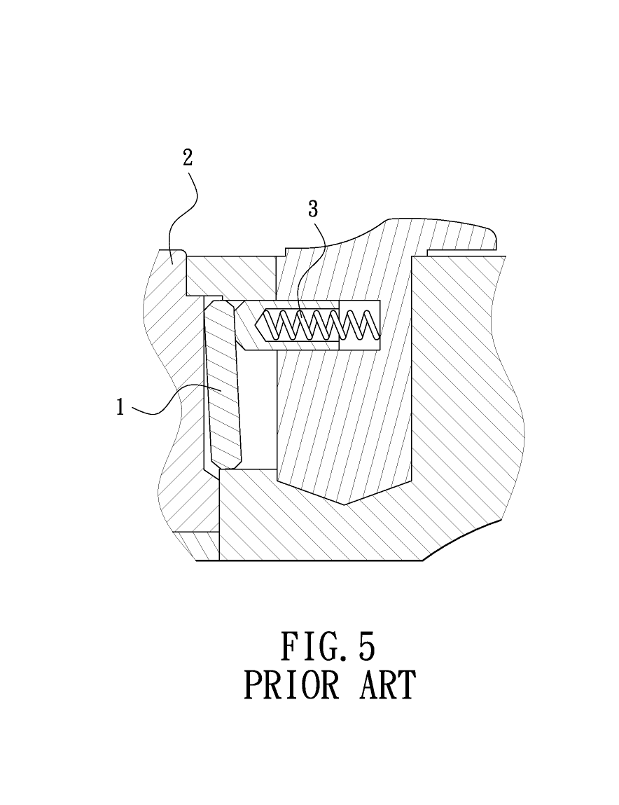

FIG. 6 is a longitudinal sectional view of a fourth conventional ratchet wrench;

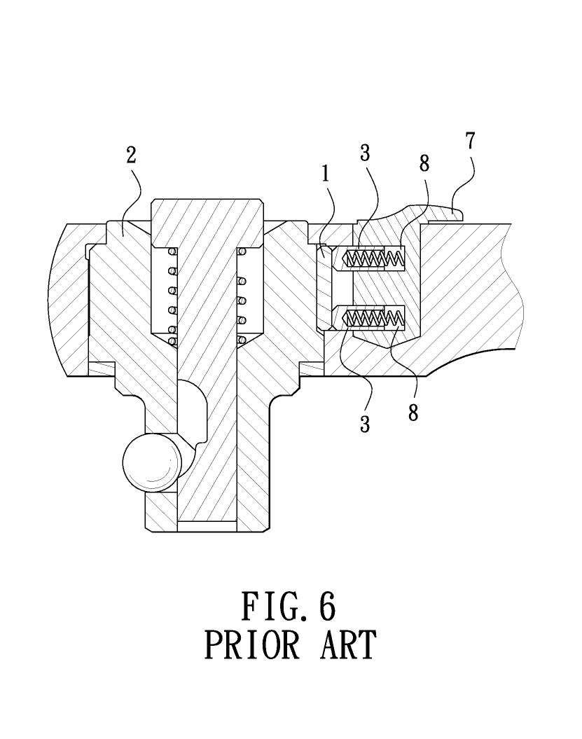

FIG. 7 is a perspective view according to a preferred embodiment of the present invention;

FIG. 8 is an exploded view according to the preferred embodiment of the present invention;

FIG. 9 is a longitudinal sectional view according to the preferred embodiment of the present invention;

FIG. 10 is a partial enlarged view according to the preferred embodiment of the present invention;

FIG. 11 is a transverse sectional view according to the preferred embodiment of the present invention;

FIG. 12 is a transverse sectional view of the preferred embodiment of the present invention when in use, showing the engagement of the detent block and the ratchet ring;

FIG. 13 is a longitudinal sectional view of the preferred embodiment of the present invention when in use, showing the state of the detent block biased by the spring and the prop pin;

FIG. 14 is a transverse sectional view of the preferred embodiment of the present invention when in use, showing the state of the detent block biased by the spring and the prop pin; and

FIG. 15 is a transverse sectional view of the preferred embodiment of the present invention when in use, showing the state of the control device after being turned.

### DETAILED DESCRIPTION OF THE PREFERRED EMBODIMENTS

Embodiments of the present invention will now be described, by way of example only, with reference to the accompanying drawings.

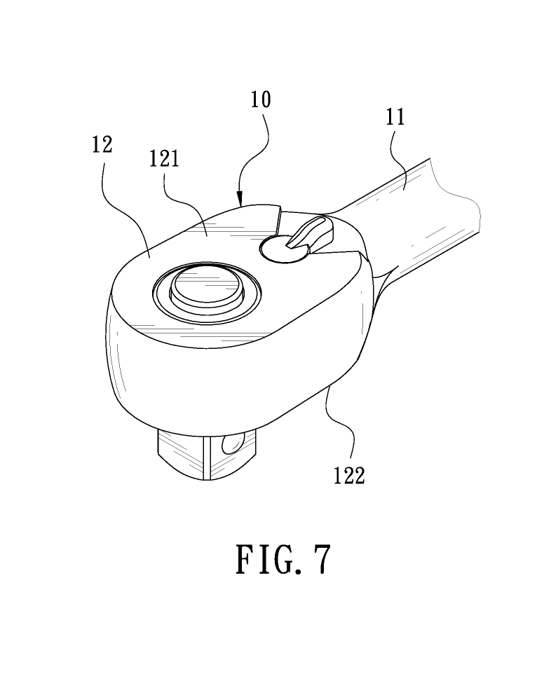

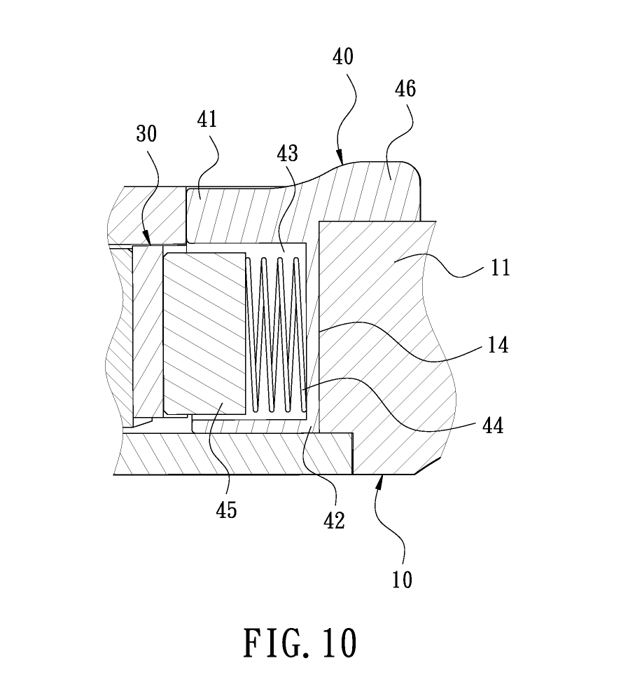

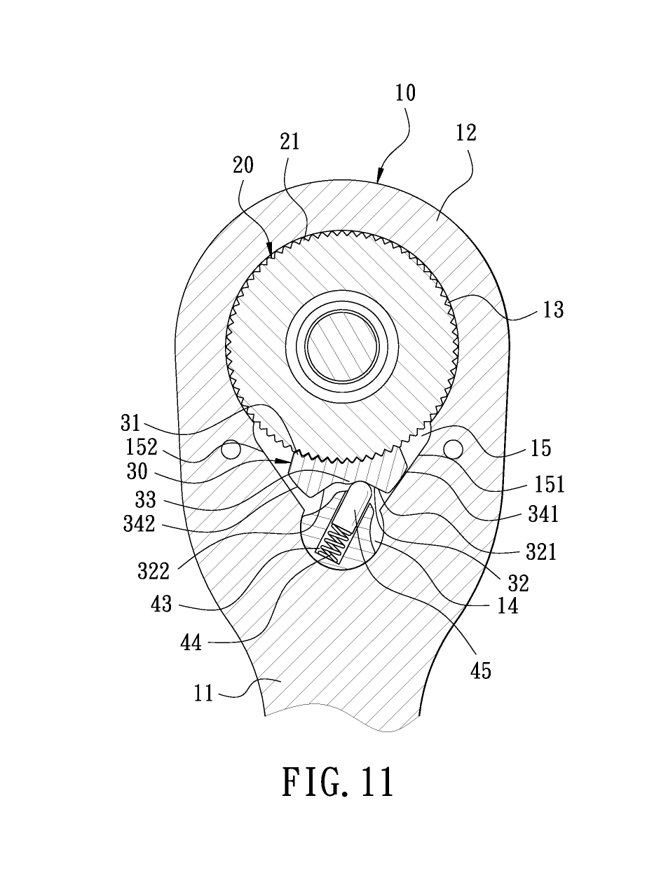

As shown in FIG. 7 to FIG. 11, the present invention discloses a ratchet wrench structure able to enhance the positioning effect of a ratchet. The ratchet wrench structure comprises a wrench main body 10, a ratchet ring 20, a detent block 30, a control device 40, and a bottom lid 50.

The wrench main body 10 has a handle 11. One end of the handle 11 has a head portion 12. The head portion 12 has a top 121 and a bottom 122. The head portion 12 has an accommodation hole 13 penetrating through the top 121 and the bottom 122. The accommodation hole 13 is substantially in the shape of a circle. The central axis of the accommodation hole 13 is perpendicular to the top 121 and the bottom 122. The top 121 of the head portion 12 has a control trough 14 close to the handle 11. The control trough 14 is substantially in the shape of a circle. The central axis of the control trough 14 is parallel to the central axis of the accommodation hole 13. The head portion 12 further has a detent trough 15 which is disposed in the accommodation hole 13 close to the handle 11 and communicates with the control trough 14. The detent trough 15 has a first holding surface 151 and an opposing second holding surface 152. The first holding surface 151 and the second holding surface 152 extend from the top 121 of the head portion 12 to the bottom 122 of the head portion 12. The detent trough 15 is gradually reduced from the accommodation hole 13 toward the control trough 14.

The ratchet ring 20 is pivotally disposed in the accommodation hole 13 of the head portion 12. The outer wall of the ratchet ring 20 is formed with a plurality of drive teeth 21. The center of the ratchet ring 20 is provided with an activating member 22. The activating member 22 is adapted to turn a workpiece. In this present, the activating member 22 is a square protruding portion corresponding to a sleeve.

The detent block 30 is disposed in the detent trough 15. The detent block 30 is selectively able to mesh with the ratchet ring 20. One side of the detent block 30, facing the accommodation hole 13, has a plurality of teeth 31 thereon. The teeth 31 are adapted to mesh with the drive teeth 21 of the ratchet ring 20. Another side of the detent block 30, facing the control trough 14, has a contact surface 32. The contact surface 32 has a concave curved shape. The middle portion of the contact surface 32 has a flange 33 corresponding to the central axis of the control trough 14. Through the flange 33, the contact surface 32 has a first contact surface 321 and a second contact surface 322 at two ends thereof. One end of the detent block 30, facing the first holding surface 151, has a first press surface 341, such that the first press surface 341 is selectively pressed against the first holding surface 151. Another end of the detent block 30, facing the second holding surface 152, has a second press surface 342, such that the second press surface 342 is selectively pressed against the second holding surface 152.

The control device 40 is disposed in the control trough 14. The control device 40 is able to selectively control the engagement relationship between the detent block 30 and the ratchet ring 20. The control device 40 comprises a control member 41. The control member 41 is disposed in the control trough 14. The control member 41 has a connecting portion 42. The connecting portion 42 extends out of the control trough 14 to be exposed in the detent trough 15, enabling the control member 41 and the wrench main body 10 to bring a relative pivot relationship. One side of the connecting portion 42, facing the detent block 30, is longitudinally formed with a rectangular limit groove 43. The rectangular limit groove 43, corresponding to the detent block 30, is longitudinally disposed on the connecting portion 42 along the control trough 14. The rectangular limit groove 43 is to accommodate a rectangular spring 44. The rectangular spring 44 has a rectangular cross-section corresponding to the rectangular limit groove 43. A prop pin 45 is provided and biased by the rectangular spring 44. The prop pin 45 has a longitudinal length substantially corresponding to a longitudinal height of the detent block 30. The prop pin 45 has a rectangular slab shape corresponding to the rectangular limit groove 43. One end of the prop pin 45 is accommodated in the rectangular limit groove 43 to contact with the rectangular spring 44. Another end of the prop pin 45 extends out of the rectangular limit groove 43 to hold against the contact surface 32 of the detent block 30 along the central axis of the control trough 14. The end of the prop pin 45, corresponding to the contact surface 32, has a convex curved shape. The control member 41 is provided with a switch member 46 opposite the connecting portion 42. The switch member 46 is exposed out of the top 121 of the head portion 12.

The bottom lid 50 is locked to the bottom 122 of the head portion 12 to surround the outer periphery of the ratchet ring 20, so that the ratchet ring 20 is confined in the accommodation hole 13 and the detent block 30 is confined in the detent trough 15.

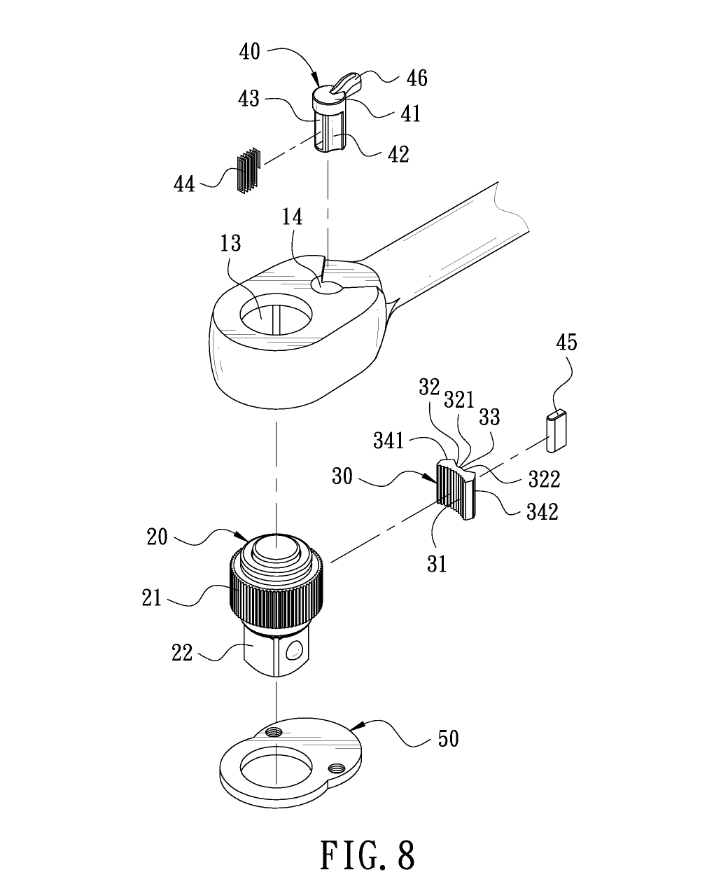

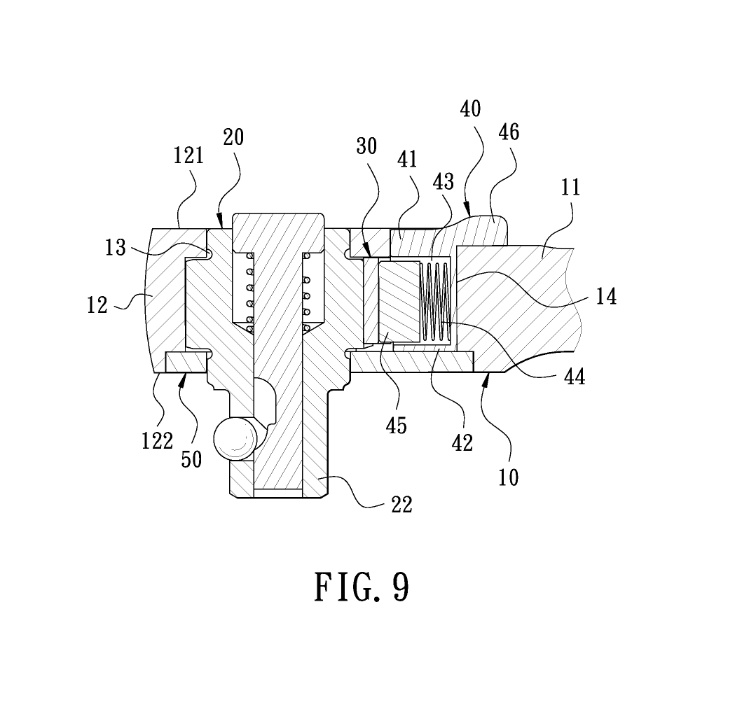

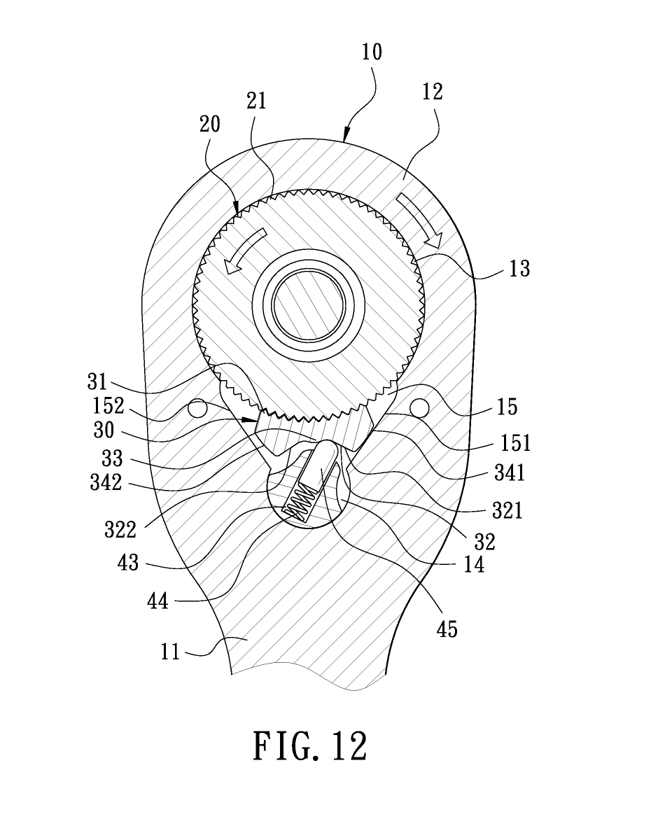

Referring to the FIG. 12, cooperating with FIG. 8 and FIG. 9, when the present invention is used to tighten a workpiece, the prop pin 45 of the ratchet wrench longitudinally holds against the contact surface 32 of the detent block 30, enabling the detent block 30 to mesh with the ratchet ring 20 and turn the ratchet ring 20 relative to the wrench main body 10. The first press surface 341 of the detent block 30 leans against the first contact surface 151. The first press surface 341 is tightly attached to the first contact surface 151 to form a large rigid support surface. Further, the prop pin 45 longitudinally holds against the contact surface 32 of the detent block 30, enabling the prop pin 45 to hold against the detent block 30 by applying a force of large area. In this way the prop pin 45 can hold against the upper, middle and lower positions of the detent block 30 at the same time, enabling the detent block 30 to tightly mesh with the ratchet ring 20 when the detent block 30 is moved. The force is applied to each tooth evenly and the engagement of each tooth is more stable, avoiding skid to cause that the applied force to the teeth is not even. The ratchet wrench not only enhances the positioning effect and stability of the ratchet but also bears a more torque value.

Besides, the prop pin 45 is able to hold against the upper, middle and lower positions of the detent block 30 at the same time. If there is greasy dirt between the detent block 30 and the ratchet ring 20 when in use, the prop pin 45 which longitudinally holds against the detent block 30 can overcome the obstruction, enabling the upper, middle and lower positions of the detent block 30 to mesh with the ratchet ring 20 at the same time. This won't have the problem of a partial engagement. The detent block 30 and the ratchet ring 20 can mesh with each other at a high speed, increasing the stability of engagement and preventing the teeth from breaking.

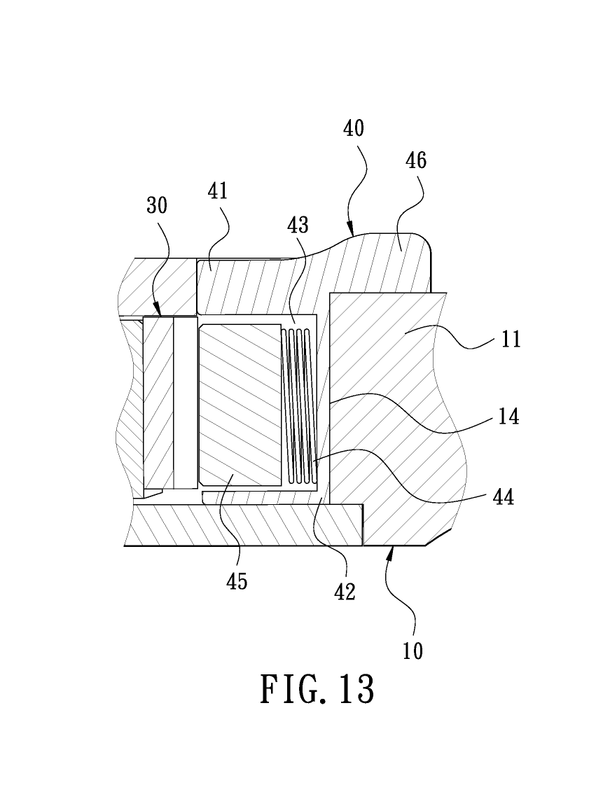

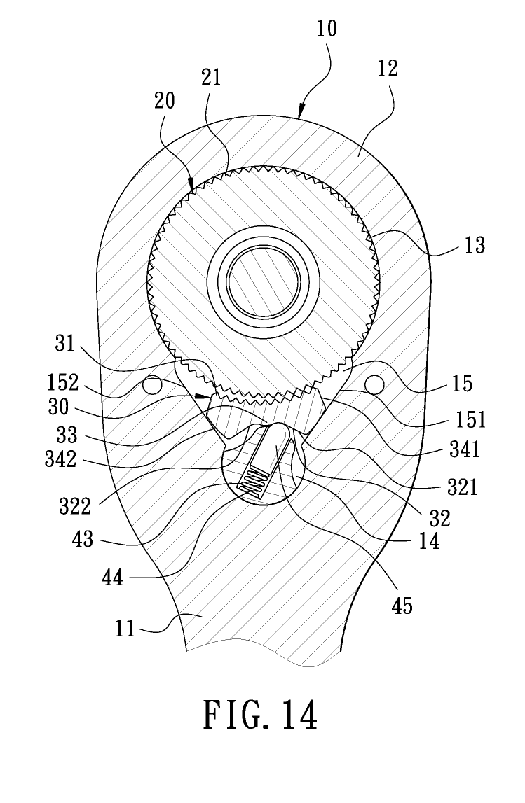

Referring to FIG. 13 and FIG. 14, when the wrench main body 10 is turned reversely, the detent block 30 is retracted rearward because the force for the ratchet ring 20 to push away the detent block 30 is greater than the force for the prop pin 45 biased by the rectangular spring 44 to hold against the detent block 30, such that the workpiece and the ratchet ring 20 won't be turned reversely along with the wrench main body 10.

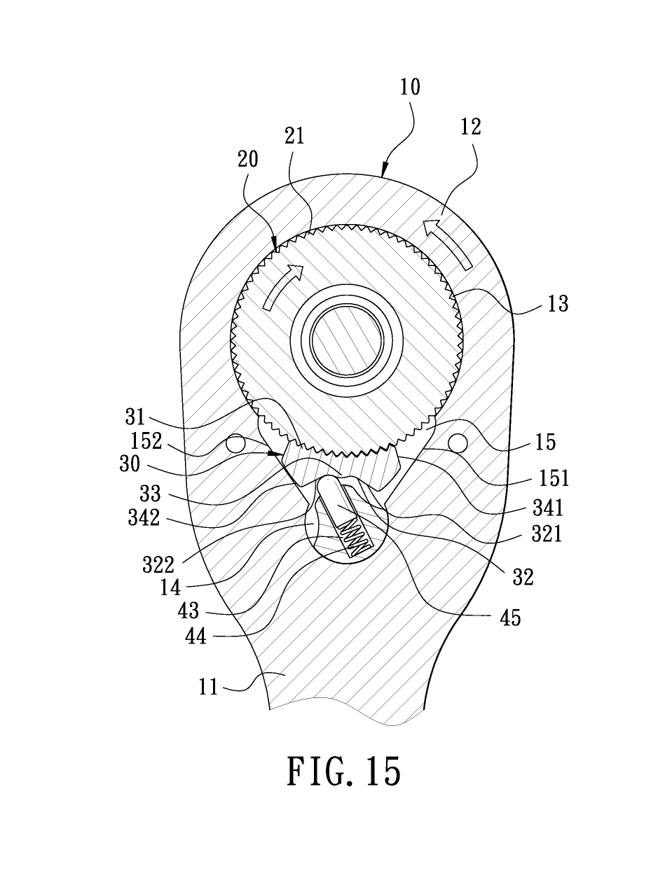

Referring to the FIG. 15, cooperating with FIG. 8, when the user wants to change a direction to operate the wrench main body 10, the switch member 46 is switched for the prop pin 45 to be turned to hold against the second contact surface 322 of the detent block 30 from the first contact surface 321 of the detent block 30. Thus, the detent block 30 forms a rigid support surface on the second holding surface 152 for the user to operate the wrench main body 10 by changing a direction.

The flange 33 provided between the first contact surface 321 and the second contact surface 322 of the detent block 30 forms a limit effect when the prop pin 45 holds against the detent block 30, such that the prop pin 45 precisely selects to hold against the first contact surface 321 or the second contact surface 322 to enhance the effect for the prop pin 45 to hold against the detent block 30, enabling the detent block 30 to mesh with the ratchet ring 20 better.

It is noted that the ratchet wrench uses the single prop pin 45 to longitudinally hold against the contact surface 32 of the detent block 30 for the detent block 30 from top to bottom to mesh with the ratchet ring 20. This can overcome the parallelism and perpendicularity tolerance problem that the conventional ratchet wrench uses a plurality of elastic positioning members to hold against the detent block. The present invention lowers the production cost and increases the production efficiency.

The features and expected effects of the present invention are described hereinafter. The ratchet wrench structure of the present invention is able to enhance the positioning effect of the ratchet. The prop pin longitudinally holds against the contact surface of the detent block to increase the area for applying the force. The detent block from top to bottom meshes with the ratchet ring. This won't have the problem of a partial engagement, increasing the stability of engagement and preventing the teeth from breaking. The prevent invention can overcome the parallelism and perpendicularity tolerance problem that the conventional ratchet wrench uses a plurality of elastic positioning members to hold against the detent block.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A ratchet wrench structure, comprising a wrench main body, the wrench main body having a head portion, the head portion being longitudinally formed with an accommodation hole and a control trough, the head portion being transversely formed with a detent trough communicating with the control trough, a ratchet ring being pivotally disposed in the accommodation hole, a detent block being provided in the detent trough, one side of the detent block, facing the control trough, having a contact surface, a control device being provided in the control trough, the control device being selective to control an engagement relationship between the detent block and the ratchet ring; characterized in that:
the control device comprises a control member, one side of the control member, facing the detent trough, is longitudinally formed with a rectangular limit groove, the rectangular limit groove is adapted to accommodate a rectangular spring, the rectangular spring has a rectangular cross-section corresponding to the rectangular limit groove, a prop pin is biased by the rectangular spring, one end of the prop pin is accommodated in the rectangular limit groove, another end of the prop pin extends out of the rectangular limit groove, the prop pin has a rectangular slab shape corresponding to the rectangular limit groove, and the prop pin has a longitudinal length substantially corresponding to a longitudinal height of the detent block;
wherein, the prop pin longitudinally holds against the contact surface of the detent block, such that the contact surface of the detent block, from top to bottom, is held by the prop pin.

2. The ratchet wrench structure as claimed in claim 1, wherein the detent trough has a first holding surface and an opposing second holding surface, the first holding surface and the second holding surface extending from a top of the head portion to a bottom of the head portion, one end of the detent block, facing the first holding surface, having a first press surface, enabling the first press surface to be selectively pressed against the first holding surface, another end of the detent block, facing the second holding surface, having a second press surface, enabling the second press surface to be selectively pressed against the second holding surface.

3. The ratchet wrench structure as claimed in claim 1, wherein the contact surface of the detent block has a concave curved shape, and a middle portion of the contact surface has a flange.

4. The ratchet wrench structure as claimed in claim 1, wherein an upper end of the control member is provided with a switch member, and the switch member is exposed out of the control trough.

5. The ratchet wrench structure as claimed in claim 1, wherein one end of the prop pin, corresponding to the contact surface, has a convex curved shape.
